(19) United States
(12) Patent Application Publication
(10) Pub. No.: US 2014/0001275 A1
(43) Pub. Date: Jan. 2, 2014

(54) Ultra-High-Pressure Fluid Injection Dynamic Orbit-Transfer System and Method Used in Aircraft

(71) Applicant: RuiQing Hong, Shanghai (CN)

(72) Inventor: RuiQing Hong, Shanghai (CN)

(21) Appl. No.: 14/004,166

(22) PCT Filed: Dec. 1, 2011
(86) PCT No.: PCT/CN2011/083309

§ 371 Date: Sep. 10, 2013

(30) Foreign Application Priority Data
Mar. 10, 2011 (CN) 201110057190.7

(51) Int. Cl. B64C 15/14

(52) U.S. Cl. CPC B64C 15/14
USPC 239/1; 239/265.11

(57) ABSTRACT

Disclosed is an ultra-high-pressure fluid injection dynamic orbit-transfer system and method to be used in aircraft. A collection of spray heads with nozzle holes are arranged symmetrically in effuser units placed on the flight surfaces or main body of an aircraft. These effusers allow more rapid and efficient changes of direction and motion.

### TECHNOLOGY

This invention involves the aeronautic and astronautic device technology, specifically a kind of ultra-high-pressure fluid injection dynamic orbit-transfer system and the method used in aircrafts.

### BACKGROUND TECHNOLOGY

Objects in motion, no matter they are space shuttles, aviation aircrafts, rockets, missiles flying in the sky, or the moving objects sailing on the water or moving underwater, will confront with the resistance of airflow or water flow in the course of the flight or sailing, and will have a need to change its moving directions, which we call “the orbit transfer”. The existing orbit-transfer methods rely on mechanical device's swing to change the motion direction of horizontal airflow or the horizontal water flow to form another acting force that makes the moving objects transfer their orbits.

### Examples of Existing Technologies for Various Moving Objects

### (I) Space Shuttles and Aviation Aircrafts:

The aerodynamic exterior of an aircraft will determine its aerodynamic characteristics under the given air flow state. The exterior of the existing space shuttles, space aircrafts and aviation aircrafts have their intrinsic design flaws, resulting more auxiliary equipment, device are needed to support them, therefore making them become more and more complicated in design, more and more difficult in operation, more and more heavy in weight and more and more energy-consuming, etc

1. The exterior design of space shuttles has a big aerodynamic flaw. It basically looks like a cigar-shaped metal rod and this kind of aerodynamic shape can not use the air force to help improve space shuttle's launch when in flight, thus it can only use the high-thrust rocket to launch, which caused huge energy to be consumed. This is not a desirable approach for aerospace industry and will inevitably be weeded out in the future.
2. The space aircrafts also imitate the exterior of the space shuttles and its take-off pattern is similar. The difference is that a space aircraft uses a large aircraft to launch and separates itself from this aircraft when in the sky, then open its carry-on rocket engines to fly out of the atmospheric layer. Therefore, the shortcomings of the space shuttles have been fully inherited and it also cannot avoid the fate to be eliminated in the future.
3. The launch of a plane mainly relies on the acting force produced by the two wings and the air. Due to the much-limited contact area between an aircraft's wing and the air, the only way to speed up the take-off speed of an aircraft to compensate the insufficient launch force of the aircraft is to improve engine's power, which is the inherent flow in the aircraft exterior design. The exterior design flaws result in significant additional energy loss.
4. An aircraft mainly make straight-line motions when in flight and the actions of take-off, landing and orbit transfer have to be finished in an instant time, therefore these flight devices are a burden for the aircraft in most of time and also an energy-consumer of the aircraft.
5. We know that the more complex a mechanical structure, the more the negative interference with each other, and the higher the probability of the damage of the equipment will be. The more complex a mechanical structure, the more difficult to control, and the lower the safety factor of an aircraft. These complex devices not only improve the degree of driving difficulty of aircrafts, but also increase the costs in staff training and device maintenance.
6. Because these orbit-transfer devices still can not meet the demand of human for aircraft, people has developed a kind of “vector engine”, which is attached at the nozzle mouth of the tail with certain rotating angles, to help aircrafts improve their mechanic performances, but the effect is not so satisfactory.
7. The comparable costs with the aircraft investment are investments in airport building and staffing, equipment and other supporting facilities.

### CONTENTS OF THE INVENTION

The purpose of the invention is to overcome the shortcomings of the existing technology and to provide a kind of ultra-high-pressure fluid injection dynamic orbit-transfer system (hereinafter referred to as: the orbit-transfer system) and the method used in aircrafts.

To change the status quo, the inventor has designed a kind of orbit-transfer system used in aircrafts, including air pipelines, effusers and the central automatic control system. The system is featured by the said orbit-transfer system along with the combined nozzle holes with the cellular geometry shape arrangement (hereinafter referred to as combined nozzle holes). Comprised of a number of spray-heads arranged by the cellular geometry shape, the foresaid combined nozzle holes are installed on the flying surfaces, either in the leading edge and trailing edge of the wing or the empennage or the abdominal fin or the canard or the symmetric side of the fuselage. The foresaid orbit-transfer system also includes one or more air pressure storage device (s) (hereinafter referred to as storage device), for which the engine installed within the aircraft supplies the gas. The air pressure storage device connects with the combined nozzle holes through the air pipelines. The downward effusers are installed in the underneath of the said air pressure storage device.

The said orbit-transfer system used in the aircrafts is featured by the fact that the said spray-heads of the combined nozzle holes can perform outside injection of gas. The said combined nozzle holes also include two kinds of spray-heads, one is to have it air injection toward a fixed direction; another is to have it air injection in changeable directions. These combined nozzle holes can be placed in multiple locations on the flight surfaces, main body of the aircraft/spacecraft or external to such locations still as part of the aircraft/spacecraft

The said orbit-transfer system used in the aircrafts is featured by the utilization in both the military and civilian aircrafts. For the said civilian aircraft, the combined nozzle holes are coherently arranged in the symmetrical upper and lower parts of the leading edge of the wings and/or other flight surfaces, constituting rows of coherently arranged upper, middle and lower combined nozzle holes. The symmetric upper and lower parts of the trailing edge (the flap and the aileron of the original wing, same as follows) of the wing are coherently arranged with the combined nozzle holes. In the symmetric sides of the tail of the aircraft are arranged the combined nozzle holes; in the symmetric upper and lower surfaces of the tail of the aircraft, there are combined nozzle holes arranged. In the bottoms of the two middle-axle-symmetric sides of the fuselage or the wing-symmetric bottoms are arranged with the effusers; within the fuselage or the wings are equipped with the air pressure storage devices.

The said orbit-transfer system used in the aircrafts is featured by the utilization in the military aircrafts without tail fins. The combined nozzle holes are coherently arranged in the symmetrical upper and lower parts of the leading edge of the said no-tail-fin aircraft wings, constituting the upper, middle and lower coherently arranged combined nozzle holes. The symmetric upper and lower parts of the trailing edge of the aircraft wing are coherently arranged with the combined nozzle holes, similarly constituting the upper, middle and lower coherently arranged combined nozzle holes. In the symmetric upper and lower surfaces of the wing's tail perpendicular to the tail fin or the ventral fin are arranged with the combined nozzle holes; in the abdominal part or the bottom of the wing, in the-middle-axle symmetric parts are arranged effusers; and within the fuselage or the wings are equipped with the air pressure storage devices. The said orbit-transfer system used in the aircrafts is featured by the utilization in helicopters. On the top of the bearing of a helicopter's propellers is installed one quadrangular or hexagonal or octagonal rotating disk. On the side of the polygonal rotating disk, there are combined nozzle holes arranged. Both the inner part of the rotating disk and the central part of the bearing are hollow, and the air is transported to the combined nozzle holes in the polygonal rotating disk on the top of the bearing through the hollow bearing.

The said orbit-transfer system used in the aircrafts is featured by the utilization in rockets or missiles. The combined nozzle holes are arranged in the surface layer of the shell of the rocket or missile described.

The said aircraft is in circular disc shape and is divided into the upper, middle and lower layers. In the middle of the upper part of the middle and lower layers of the said aircraft, the storage device is arranged. In the central point of the middle layer of the aircraft are arranged four outlets of the exhaust effusers in four directions with 90-degree angles and the said four outlets of the exhaust effusers have the upper and lower layers of nozzle mouths respectively. In the middle of the inner side of the upper and lower layers of nozzle mouths are equipped with effuser valve. In the bottom of the said storage device, there is a row of circular-type effusers with downward injection; in the upper and lower surface layers of the said aircraft, there are combined nozzle holes respectively.

The said orbit-transfer system used in the aircrafts is featured by the said effusers and the combined nozzle holes that are arranged with the circular shape radiating outward from the center of the circle.

The said orbit-transfer system used in the aircrafts is featured by the certain degree of angle between the nozzle mouths in the upper and lower layers of the middle layer effusers and the nozzle mouth valve of the aircraft.

The said orbit-transfer method used in the aircrafts is featured by its following application methods: (A) Flight: when the two adjacent effusers in the middle layer of the disc aircraft blow off, the flying disc will make forward horizontal flying movement; when closing one effuser at one side and open another adjacent effuser in other side to blow off, the flying disc will make 90 degree orbit-transfer flight; when close two opening effusers and open other two opposite effusers to blow off, the flying disc will be immobilized or do backward horizontal flying movement. (B) Aircraft take-off: open the downward-injection effuser, allowing the aircraft to launch vertically to a certain height, then open No. 3 and No. 4 effusers to make the aircraft advance horizontally; when the aircraft crawling up, close the effuser making vertical advancement, at the same time, open the combined nozzle holes in the specified location of the lower layer control device. Because the horizontal airflow in the lower surface of the flying aircraft is resisted by the vertical airflow from the combined nozzle holes, the direction of the airflow has to change and the aircraft will move with its head upward, resulting in a slanted upward orbit-transfer flight; (C) Aircraft landing: close No. 3 and No. 4 effusers and the aircraft will maintain its flying under the inertia of flight speed. Open the combined nozzle holes in the specified location of the upper controller to blow off, because the horizontal airflow in the upper surface of the aircraft is resisted by the vertical airflow from the combined nozzle holes, the direction of the airflow has to change and the aircraft will move with its head downward, resulting in a slanted downward orbit-transfer flight. (D) Using the combined nozzle holes to brake: when the aircraft needs to be immobilized while it is doing horizontal flight, close No. 3 and No. 4 effusers, due to inertia, the aircraft will maintain its forward flying; then open the combined nozzle holes on the specified locations of the upper and lower controllers, the horizontal airflow will have a vertical confrontation with the airflow injected and resist the forward movement of the aircraft, resulting in a braking effect. (E) Left-turn orbit-transfer: when an aircraft needs a left-turn orbit change while doing horizontal flight movement, open the 45 degree turn-left combined nozzle holes at the specified location of the upper and lower controllers, as the horizontal airflow is encountered the resistance of the injected airflow barrier, the heading of the aircraft will turn to left direction, resulting in the change of the orbit. When the orbit-transfer angle is achieved, close the combined nozzle holes and the aircraft will fly along the changed direction. (F) Right-turn orbit-transfer: when an aircraft needs a right-turn orbit change while doing horizontal flight movement, open the 45 degree turn-right combined nozzle holes at the specified location of the upper and lower controllers, as the horizontal airflow is encountered the resistance of the injected airflow barrier, the heading of the aircraft will turn to right direction, resulting in the change of the orbit. When the orbit-transfer angle is achieved, close the combined nozzle holes and the aircraft will fly along the changed direction.

Compared with existing technologies, the biggest advantage of the invention is low equipment cost, easy operation and maintenance, resulting in substantial reduction in the aeronautic and astronautic costs and there is no need of the large satellite launch center with complex equipment or large airport runway, instead only an airport is needed. When the space aircrafts has completed its one flight task and is able to take off again after maintenance. People can make their space travelling as easy as taking an aircraft. Even without going the space, people can conveniently use it flying to the other side of the ocean for a visit of their friends. In addition, in terms of military value, it can also be converted into the space battle plane, the space bomber and the space transport plane, etc. More over, the space aircraft has strong penetration and defense ability. It can easily break through enemy's defense system and attack the enemy and destroy the enemy's effective strength.

### DESCRIPTION OF FIGURES

FIG. 1: The plane diagram showing the invented combined nozzle holes 1 with the cellular geometry shape amounting on either the aircraft tail's two sides or the empennage or the ventral fin; for example, each square hole represents a cellular spray head 2;

When the controller specifically opens the A group or B group, the diagram of the geometrical shape formed by the combined nozzle holes;

When the controller specifically opens both the A group and B group, the diagram of the geometrical shape formed by the combined nozzle holes;

FIG. 2: The diagram showing the combined nozzle holes when the invented combined nozzle holes 1 are installed in the wing's leading to edge or the trailing edge (the original flap, aileron location) or the canard of an aircraft; each square hole represents a cellular spray head 2;

When the controller specifically opens the C group or D group, the diagram of the geometrical shape formed by the combined nozzle holes;

When the controller specifically opens both the C group and the D group, the diagram of the geometrical shape formed by the combined nozzle holes;

FIG. 3: The layout diagram of the invention used in the military and civilian dual-purpose aircraft;

The element 3 shows the combined nozzle holes installed on the leading edge of the civilian aircraft;

The element 4 and element 5 show the combined nozzle holes installed on the trailing edge of the civilian aircraft;

The element 6 shows the combined nozzle holes installed on the two symmetrical sides of the tail of the aircraft;

The element 7 shows the combined nozzle holes installed on the upper and lower symmetrical surfaces of the tail of the aircraft;

The element 8 shows the combined effusers that can make vertical takeoff and landing installed on the bottom of the two symmetric sides of the fuselage;

FIG. 4: The layout diagram of the invention used in the military no-tail aircrafts

The combined nozzle holes are installed on the symmetric left and right sides and the upper and lower surfaces of the tail of the aircraft, element 9;

The combined effusers that can make vertical takeoff and landing are installed on the symmetric parts of the belly of the aircraft, element 10;

FIG. 5: The sectional drawing of the invented combined nozzle holes 1 mounting in the leading and trailing edges of the wing;

FIG. 6: The diagram of the upper, middle and lower layers of a disc aircraft;

element 1 shows the combined nozzle holes;

element 11 shows the air pipeline of the combined nozzle holes;

element 12 shows the air pressure storage device;

element 13 shows the effuser that can make vertical take-off and landing;

element 14 shows the dynamic effuser;

element 15 shows the valve in the dynamic effuser;

element 16 shows the parting line between the upper and the lower layers;

FIG. 7: The layout of the middle layer when the invention is used in the disc aircraft and the diagram of the aircraft's flying direction when opening the specified effuser; Element 17 is the air pressure storage device;

7A The diagram of 14A, 14B, 14C & 14D effusers with crossing layout in the middle layer of the marked disc aircraft;

7B The horizontal flying diagram of the aircraft when the 14C and 14D effusers are specifically open under the instruction of the controller;

7C The horizontal flying diagram of the aircraft when the 14A and 14B effusers are specifically open under the instruction of the controller;

7D The horizontal flying diagram of the aircraft when the 14B and 14C effusers are specifically open under the instruction of the controller;

7E The horizontal flying diagram of the aircraft when the 14A and 14D effusers are specifically open under the instruction of the controller;

7F The sectional drawing of the flying aircraft;

FIG. 8: The upward-viewing figure of the mouths of the 8 downward-injection effusers 14 installed on the bottom of the lower layer of the flying aircraft;

FIG. 9: The design layout of application in the orbit-transfer of the combined nozzle holes installed on the upper and lower layers of the disc aircraft;

FIG. 10: The working state of orbit transfer of the disc aircraft when the invention is used and the controller has specifically opened the certain part;

10A The working state of upward orbit transfer of the disc aircraft when the invention is used and the specified nozzle holes of the working part of the lower part are opened;

10B The working state of downward orbit transfer of the disc aircraft when the invention is used and the specified nozzle holes of the working part of the upper part are opened and make upward air injection;

10C The working state of the breaking made by the invention on the disc aircraft when the nozzle holes of the specified work part in the upper and lower layers are opened and make simultaneous air injection.

10D The working state of the turn-left orbit transfer made by the invention on the disc aircraft when the specified work part in the upper and lower layers is opened, said opening denoted by black line;

10E The working state of the turn-right orbit transfer made by the invention on the disc aircraft when the specified work part in the upper and lower layers is opened, said opening denoted by black line;

FIG. 11: The application of the invention in the helicopters;

11A is the upward view of the octagonal rotating disk;

11B is the side view of the octagonal rotating disk;

18 is the view of disc surface of the octagonal rotating disk;

19 is the bearing of the rotating disk and its connection;

20 shows the hollow center of the bearing;

21 is one of the sides installing the invention in the octagonal rotating disk;

22 shows the nozzle holes specifically opened by the controller when the invention is applied to the rotating disk on the top of the bearing in the helicopter propeller;

FIG. 12: The sectional drawing of the propeller bearing and the top rotating disk;

23 shows the hollow inner part of the rotating disk connecting with the bearing, which can serve as the air channel;

1 shows the installed combined nozzle holes;

FIG. 13:

13A 24 is the working diagram when the invention is applied to rockets, missiles and the specified nozzle holes are open for air injection;

13B 25 and 26 are the working diagram when the invention is applied to the rockets, missiles for orbit transfer and the controller opens the specified nozzle holes in the symmetrical parts;

### THE SPECIFIC IMPLEMENTATION METHODS

The following will make detailed descriptions on the invention by using attached Figures. This kind of manufacturing technology is very clear for the professionals in this field.

The invention applies to civilian and military aviation and aerospace fields.

### The Effects Applied in the Modern Aircrafts:

When the combined nozzle holes are used in the tail or ventral fin of the military or civilian aircraft with tail as injection parts, the cellular geometric shaped air injection effect.

See FIG. 4: The combined nozzle holes are installed in the two opposite sides of the aircraft tail and in the symmetric sides of the upper and lower layers of the tail, where each square hole represents a spray head of one combined nozzle hole; after programming, a great of ever-changing air injection can be formed.

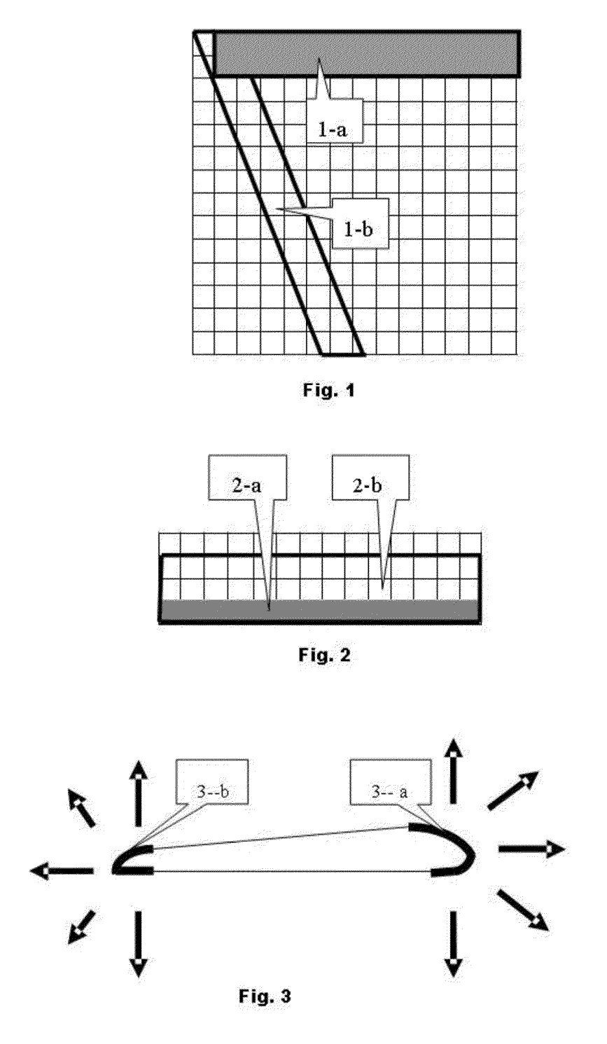

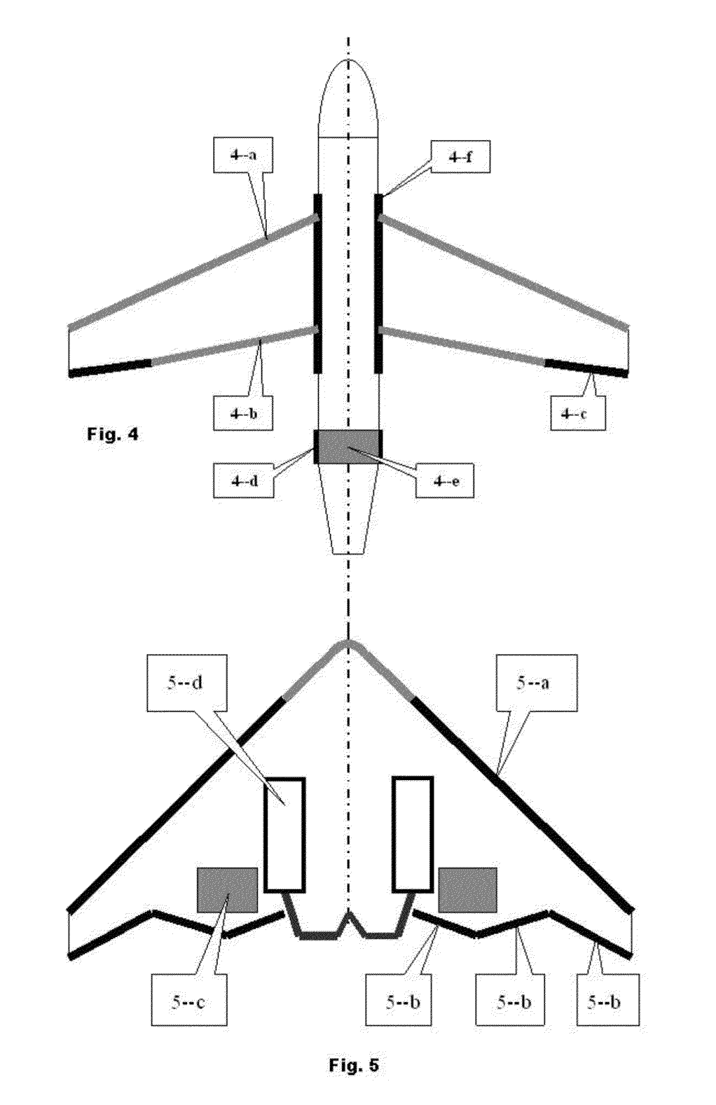

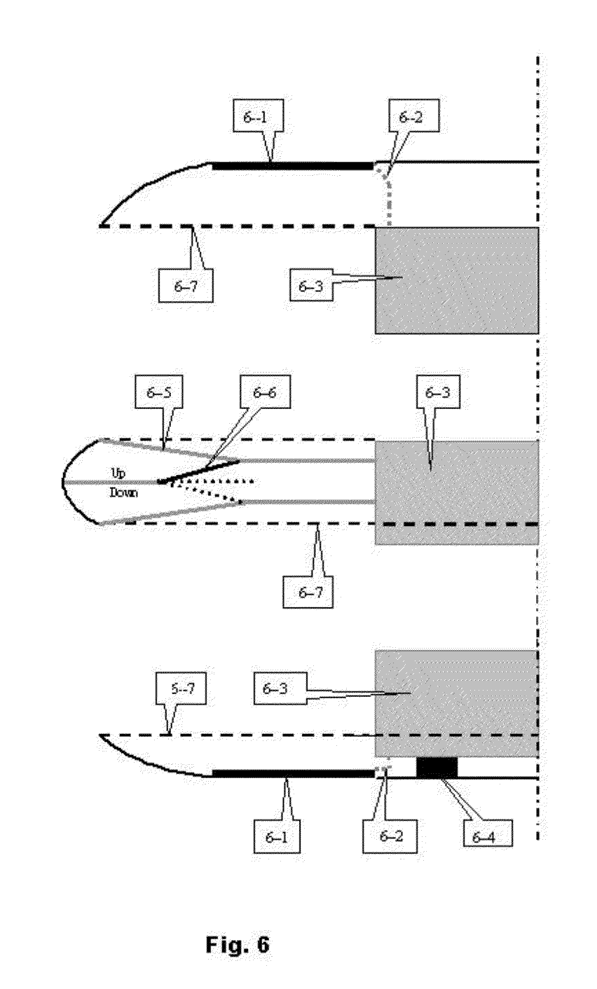

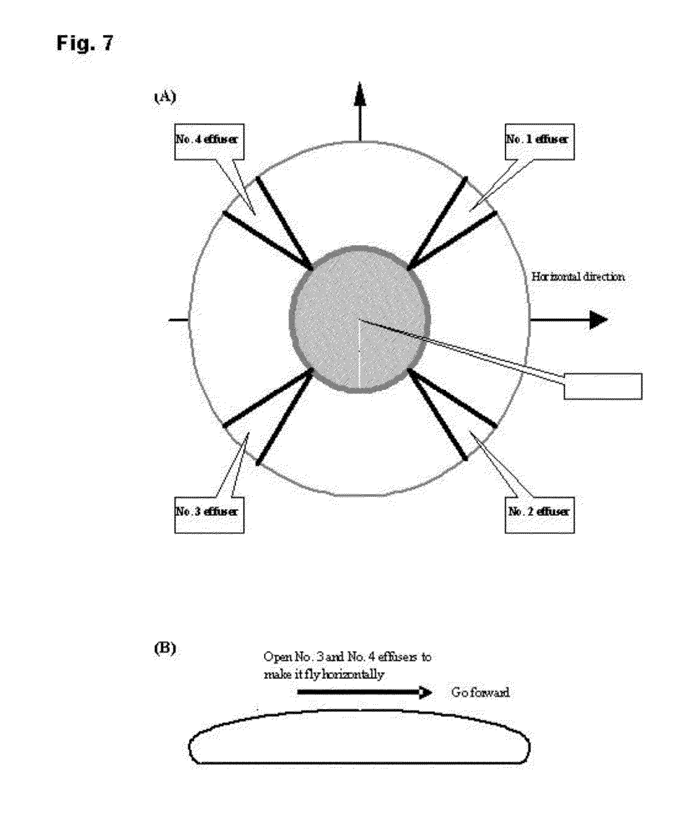

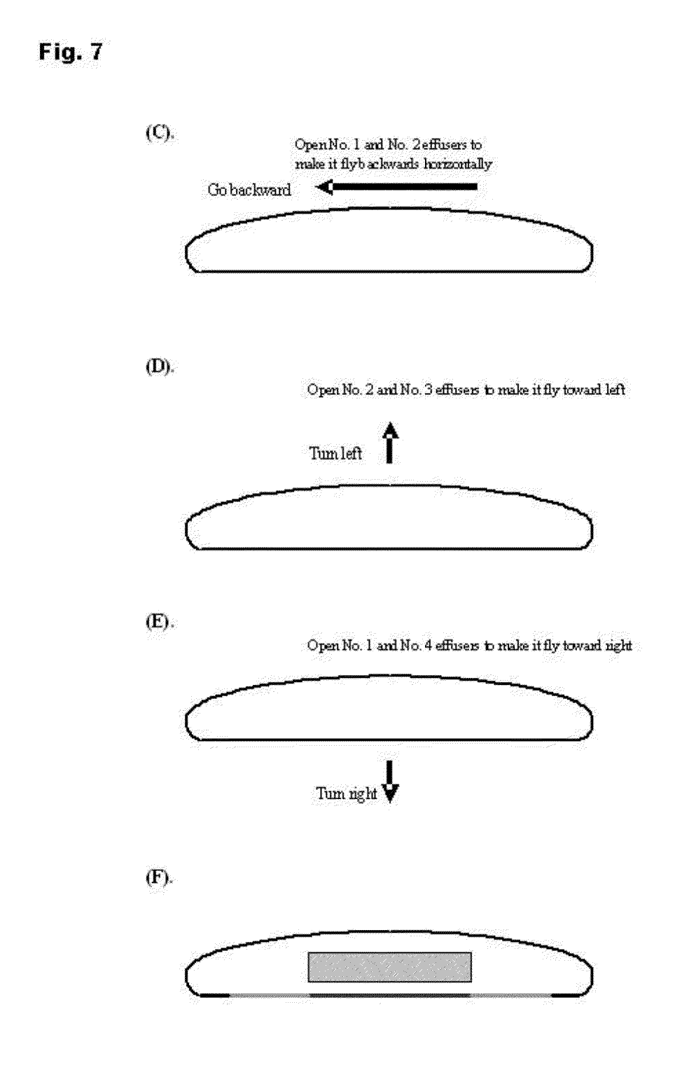

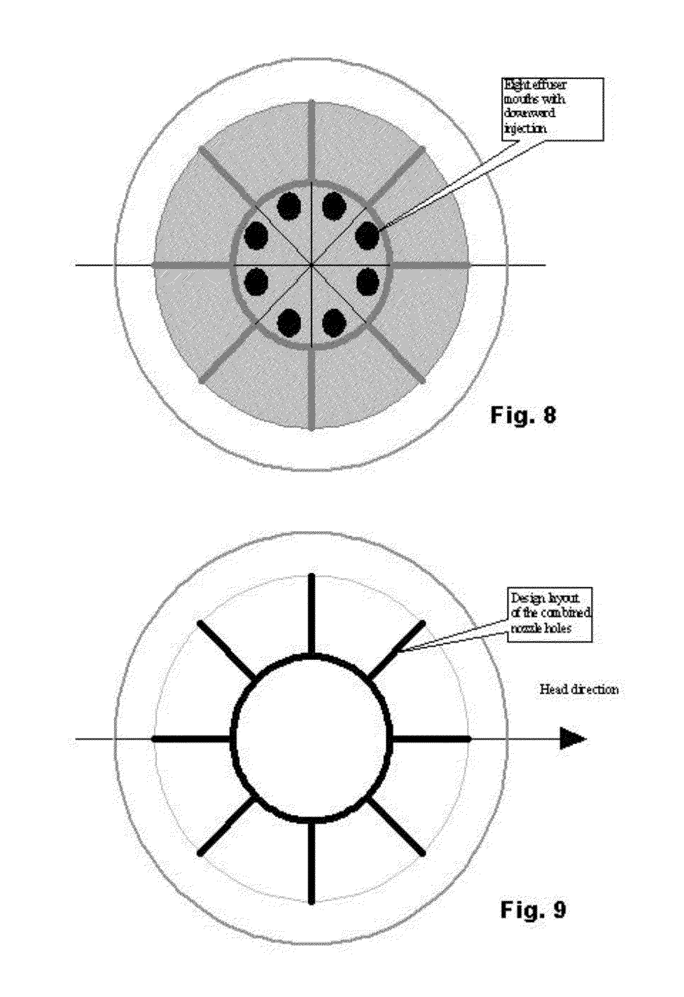

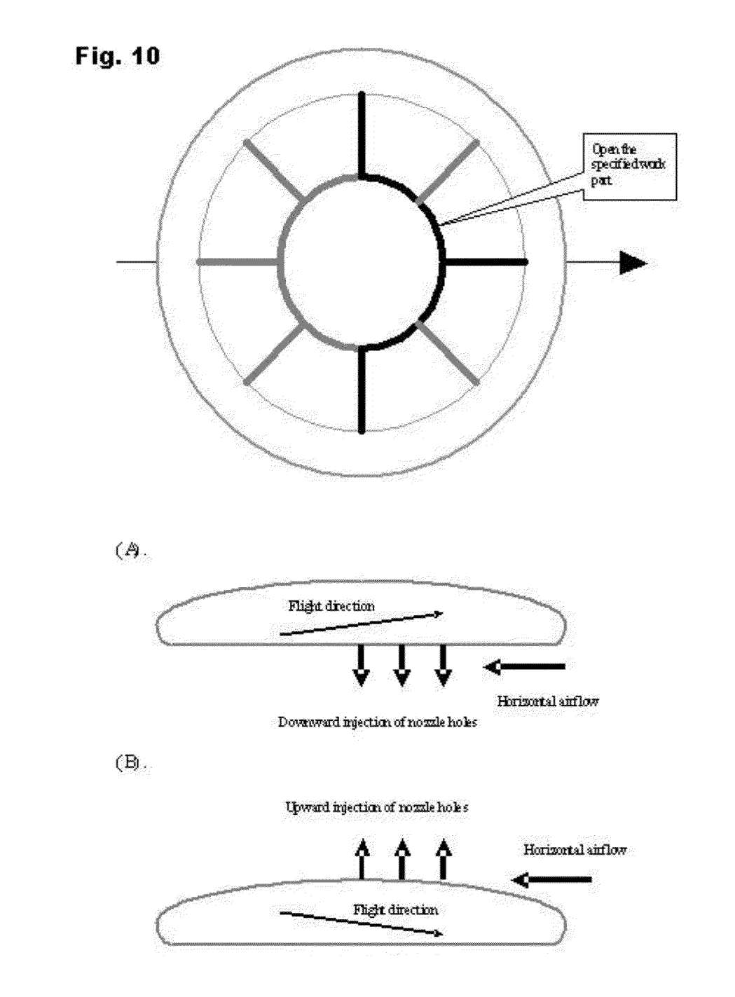

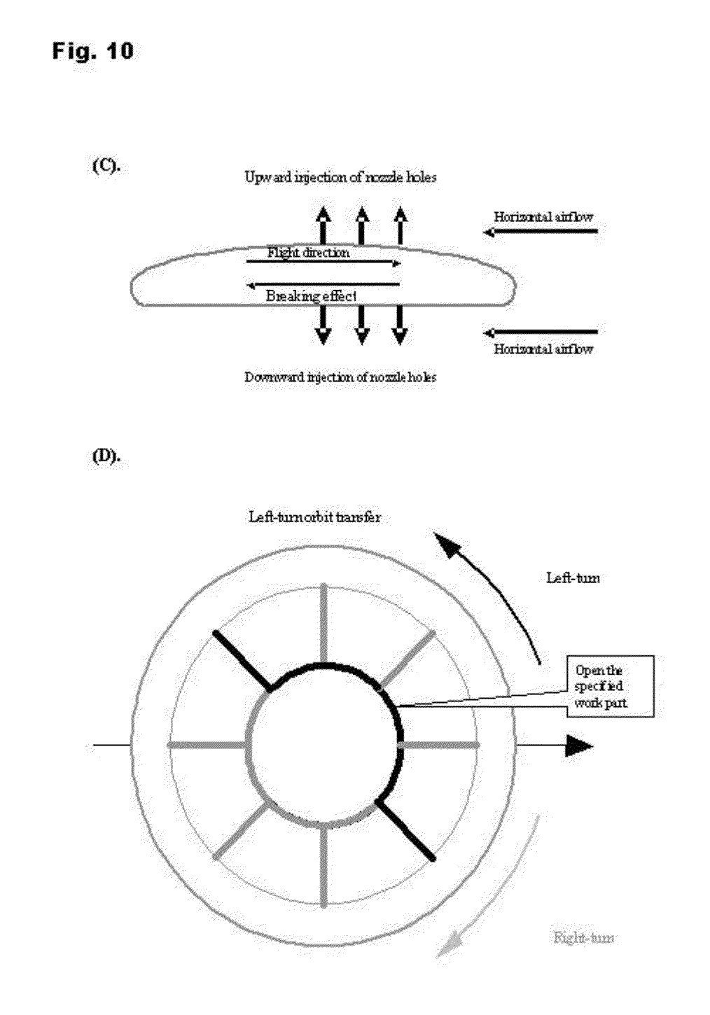

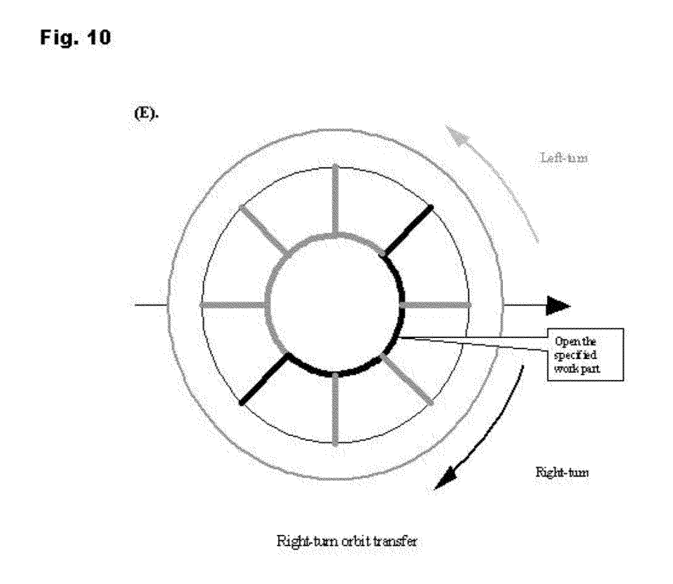

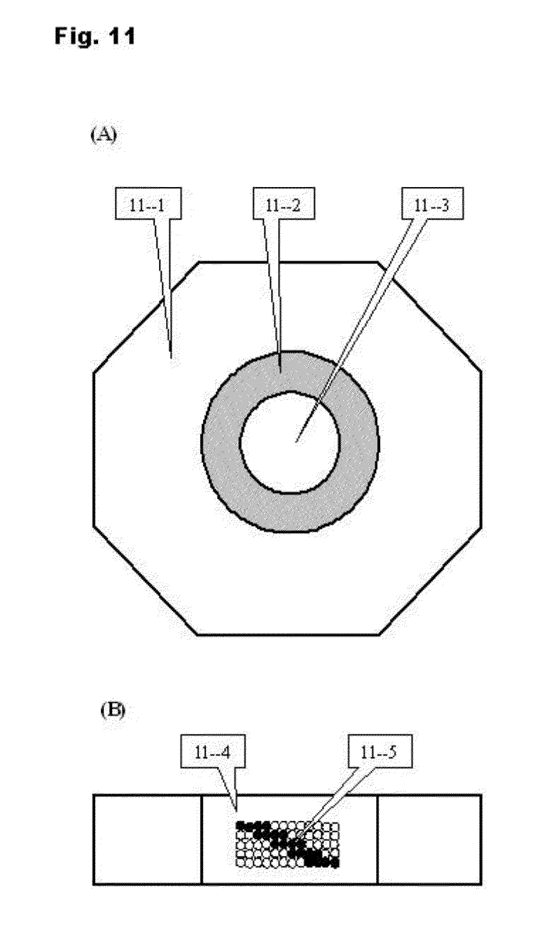

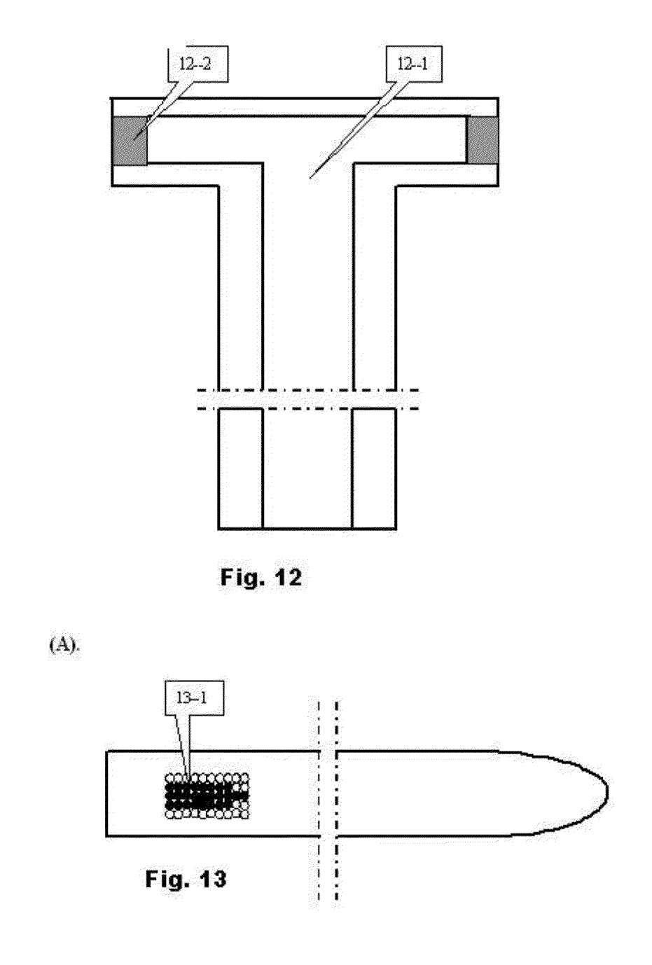

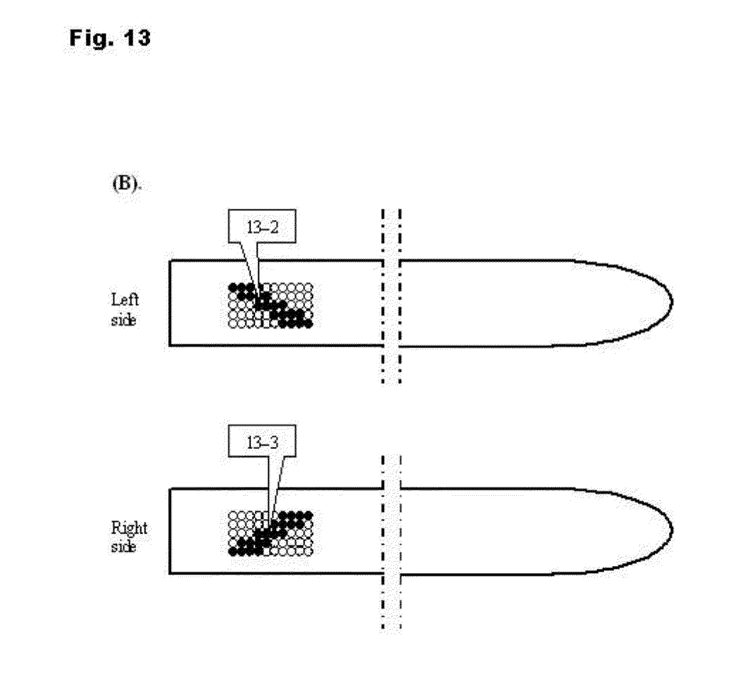

Example of FIG. 1: when the combined nozzle holes are open, it generates a “-” shaped injection layout; when the combined nozzle holes are open, it generates a slanting rectangular shape; when the to combined nozzle holes are simultaneously open, it forms an L-shaped injection layout.

When the combined nozzle holes are used as injection parts in the wing flap, ailerons or canard of the military aircraft without tail, the cellular is geometric shaped air injection effect.

In FIG. 5: In the original part location of aircraft wing's flaps, ailerons or canard the upper, middle and lower coherent and symmetrical combined nozzle holes are installed where each square hole represents one spray head of a combined nozzle hole, after programming, a single row shaped injection or multi-row shaped air injection can be formed.

Example of FIG. 2: the gray color section is the single row injection layout; the part with black lines are double-row injection layout; if necessary, it can generate the three-row, tour-row and above layouts of combined nozzle holes.

The flaps, ailerons, tail (including horizontal tail and vertical tail), canard and ventral fin, etc. installed in the existing aircrafts are all used for take-off, landing, balance, orbit transfer, etc; or used for short-distance take-off, landing, rolling for the battle planes. The fundamental principle of these orbit-transfer devices is: when these devices are open, the horizontal airflow will encounter the resistance, so that it has to change the direction, resulting in the orbit-transfer effect of to the aircraft.

The invented system can help aircrafts to remove all complicated orbit-transfer assistive devices other than the aircraft fuselage and wings, so as to greatly simplify the aircraft's internal and external structure; in addition, by removing the weight of these device, the aircraft can add is more fuel or supplies, so that the economic benefits of flying can be greatly improved, and can play a positive role in certain aspects for the design of future aviation aircrafts. There are different effusers and the combined nozzle holes installed in different locations of an aircraft, at the time of orbit transfer, the operator can open the effusers and the combined nozzle holes in different locations of aircrafts, so that it can provide the aircraft with vertical take-off, vertical landing, hovering, balancing, swerving orbit-transfer and rolling effects.

See FIG. 4 and FIG. 5: show the originally locations installing the flaps and ailerons in the leading edge or trailing edge of the wings currently have been modified to install the combined nozzle holes, according to the controller's command, the spray heads can inject airflow to more than one directions to obstruct the pass of the horizontal airflow and make the horizontal airflow to change its direction.

See the location the effect of the installed combined nozzle holes can replace the functions of the full-motion canard of the battle aircraft.

The application of the invention in the disc aircrafts including following units:

1. Engine: According to the different application requirements of the aircraft to choose different “rocket engine”, “aircraft engine”, or other is types of engine. One or more engine can be chosen for a combined use to provide power for the aircrafts.
2. The cooling system of aircrafts: used to avoid the dysfunction of some engine parts or other devices due to the high temperature generated by the engine. Cooling can protect the engine parts and other parts of the equipment to work normally.
3. The ultra-high-temperature resistant, high-pressure energy storage device (hereinafter referred to as: the storage device): as there is high temperature, high pressure energy generated by the engine, to preserve such high temperature, high pressure energy, there must be a storage device that can resist the ultra-high-temperature and high pressure. The energy in the storage device is used for: firstly, the provision of the energy source when the aircraft is flying in the atmospheric layer with low speeds; secondly, the provision of the energy source for the orbit-transfer of the “ultra-high-pressure fluid injection dynamic orbit-transfer system”.

The number of the storage devices selected depends on the design to requirement of the aircraft. It can select one or several storage devices for combined use. The advantage to use multiple storage devices is to be able to obtain the steady air pressure in every individual storage device to avoid the mutual pressure interference when making air injection among different routes of spray heads, which play a is pressure-stabilization role.

4. The ultra-high-temperature & high pressure resistant air pipeline: is designed and laid based on different usage requirements of aircrafts. Connect the pressure storage device with the effusers or the combined nozzle holes. The pipeline mainly plays a role in transporting dynamic gas for all routes of effusers and spray heads.
5. The ultra-high-temperature & high pressure resistant flexible effusers: according to the characteristics of exterior design of an aircraft, in the necessary locations of the aircraft, one or more air injection effuser can be installed to provide an aircraft with energy for its vertical launch, horizontal flight, hovering and orbit transferring, etc.
6. The ultra-high-temperature & high pressure resistant flexible or fixed spray heads: According to the aircraft's design requirements, it can re-arrange the cellular geometric shaped spray heads to different combinations of spray heads with different density, different diameters of nozzle holes, fixed or rotating spray heads and any geometric shapes (hereinafter referred to as the combined nozzles holes) and install them to in the required inner part of the shell of the aircraft and be used along with the effusers, which can help the aircraft to make vertical launch & landing, hovering, balancing, breaking, super-maneuvering orbit transfer. This system can replace a variety of devices with “visible orbit-transfer” in the modern aircrafts.
7. The central automatic control system: it is the central automatic control system of aircrafts and connects with all devices in the aircraft through cable wires. It will automatically control, command, and deliver all instructions of the actions on the aircrafts according to the set program.
8. Other important auxiliary equipment: The ultra-high-temperature & high-pressure-resistant air pressure regulator; the ultra-high-temperature & high-pressure-resistant valves and so on.

The Application Results of the Storage Device:

We take the stored ultra-high temperature & high-compressed air energy as aircraft's energy carrier, along with the system of the invention to explain aircraft's vertical takeoff & landing, low-speed horizontal flying, hovering and orbit transfer and other issues.

We know that when an aircraft is making a low-speed flying in the sky, it does not need “the first cosmic velocity” or “the second cosmic velocity” energy, we only need to control the energy source released to from the work of the “rocket engine” and store this energy released by it in the storage device to be as the energy source of aircraft's vertical takeoff & landing, low-speed horizontal flying, hovering and orbit transfer, etc and, according to the action requirement of the aircraft, the central control system shall control the release volume to help aircraft to is complete these actions.

When the aircraft needs “the first cosmic velocity” or “the second cosmic velocity” to go through the atmospheric layer, we then release large amounts of energy or called thrust augmentation, allowing the thrust generated by the energy to be released from the effuser to propel the aircraft directly, namely shooting the arrow at the target and releasing according to the needs.

Laying Method of the Effusers and the Application Results of the Effuser when Making Injection:

Firstly: I, the inventor, when doing design, have divided the structure of an aircraft into upper, middle and lower layer, and the storage devices are placed at the middle of the upper part of the middle and lower layer in the aircraft. (See FIG. 6)

Secondly: In the center of the middle layer of the aircraft, four exhaust effuser outlets are arranged in four directions with 90-degree angles. The four outlets are marked as 14A, 14B, 14C & 14D The purpose to arrange to the four effusers with 90 degree angles centered in the central point of the aircraft is, when the two forces intersect at the center, it will jointly become a forward acting force, when the two adjacent effusers make injection, the aircraft would fly horizontally forward; when closing one effuser on one side and open the adjacent effuser on the other side to is blow off, the aircraft will make 90 degree angle of orbit transfer movement; When closing two open effusers and opening other opposite effusers to blow off, it will immobilize the aircraft or make the aircraft to reverse the direction of horizontal flying. Every effuser is controlled by the central control system, and every effuser has its independent systematic set-up for its opening and closing. Every effuser can use the method of installing the injection valve to adjust the injection force of each effuser mouth. The installation of the dam-board can change the direction of air injection.

Thirdly: In the underneath of the air pressure storage device, there is a row of circular shape effusers with downward injection and the quantity of the effusers can be determined according to the needs. This group of effusers mainly serves as providing aircraft's driving force in vertical takeoff & landing and hovering.

The Design of the Combined Nozzle Holes Arrangement and the Application Results:

The combined nozzle holes are installed in surface layer of the aircraft's upper and lower layers. When the aircraft need orbit transfer movement when doing horizontal flying, the spray heads will make air injection under the instruction of the controller, the moving direction of the blow-off gas is perpendicular to the moving direction of the airflow on is the surface of the aircraft, when the blow-off high-pressure gas acts as a wall to hinder the pass of the horizontal airflow, the horizontal airflow will force to change its moving direction, thus forming an acting force moving to another direction and the aircraft is relying on this acting force to realize its orbit transfer. When the aircraft has completed its orbit transfer, the control system will close the nozzle holes so that the aircraft can resume its horizontal flying movement.

The spray angle of the fixed spray heads can be set according to the needs and the angle-changeable spray heads can change the injection angles.

The Results of the Combined Applications of the Aircraft Effusers and the Combined Nozzle Holes:

We install the cellular geometry shaped combined nozzle holes in the surface layer of the upper and lower layers of the aircraft. When the combined nozzles holes are jointly used with aircraft's effuser device, the aircraft will have a variety of changes in flight, which is the to maneuver orbit transfer of flying disc aircraft type that we are looking forward to seeing.

As the aircraft is a round dish-shaped object, the effusers and the combined nozzle holes are arranged with a circular type of radiation outward from the center, thus there is no clear head or tail direction for a is aircraft and the four directions can be called as the head or tail. Only if we specifically name a certain part as the head, this direction is the head of the aircraft.

In addition, because of the characteristics of the aircraft, combined with the following figure illustrations, let us show, after the aircraft has installed the “ultra-high-pressure fluid injection dynamic orbit-transfer system”, how the approach that is based on the combined nozzle holes and supported by the effusers can make the aircraft do up and down, left and right, etc any direction orbit transfer tlight.

The Cooling Effects on the Surface of Aircrafts

As the aircraft can make either low-speed flight, or super-high-speed flight, when the aircraft in high speed flying achieves certain speed, the operator can use foresaid left and right orbit transfer method and set the flight mode of the aircraft to be: the mode in which it will take the center of the aircraft as the centripetal force to make the forward rotation flight. This flight mode can avoid the generation of shock wave phenomena (or to call the sonic boom), because the force bearing points on the surface of the flyer are dissolved by the centrifugal force of high-speed rotation, this can greatly lower the high temperature generated by the direct force bearing and the friction with the airflow on the aircraft's surface, and can significantly protect the surface of the aircraft.

The Aircrafts Navigate on the Water:

Since aircraft's all orbit transfer actions are completed through the opening or closing of the exhaust valve, and the exhaust valve only allows the outward movement of gas emissions, therefore when the exhaust valve in the lower layer of the aircraft is fully closed, it can float on the water. When opening the effuser at the tail to blow off, the aircraft became a water sports device sailing on the water. The combined nozzle holes on the upper and lower layers of the aircraft along with the gas injection can help aircraft to do balancing, orbit changing and other actions.

The Aircrafts Navigate Under Water

When the aircraft has closed all the vents, it is an airproof object and can float on the water. If we design a water storage compartment within the aircraft (similar to the submarine's principle), or release a water bag (similar to the principle placing an air bag in the outer edge of a to hovercraft) to which add some water, the aircraft will sink; when it sinks to the desired depth, the opening of effuser to blow off will make the aircraft become a underwater motion device. The balance and orbit transfer principle under water is the same as that when flying in the sky, the difference is that, when flying in the air, the resistance to the aircraft is from the air, while moving under water, the resistance to the moving object is from water. As the aircraft has installed the “ultra-high-pressure fluid injection dynamic orbit-transfer system”, the orbit-transfer under water is just as easy as it does in the air.

The Invisible Role of Aircrafts

As there are no any protrusions on the surface of the aircraft, and all the orbit transfers will use the combined nozzle holes; in addition, due to its circular shape and the outer circle design with 30 degree angle, all of which can make an aircraft have a good invisible effect.

See FIG. 7: The Design and Application of the Effuser Arranged in Four Directions in the Middle Layer of Aircrafts The effect to make cross arrangement of effusers centered on the center of the aircraft is, when two acting forces intersected at the center, they will become a combined forward acting force the advantage of four-direction arranged effusers is: when opening the adjacent 15C and to 15D effusers, the aircraft's flight direction is along the horizontal direction); when opening the adjacent 15A and 15D effusers, the aircraft will be immobilized, or make reverse horizontal flight; when open 15B and 15C effusers, the aircraft will fly horizontally toward left 90-degree direction with when opening 15A and 15D effusers, the aircraft will fly horizontally toward right 90-degree direction.

See FIG. 8: Design and Application of the Effusers in the Lower Layer of the Aircraft

It is selected to arrange the downward straight-emission effusers for vertical take-off and landing in the center of the inner ring of the lower layer of the aircraft to provide aircrafts with downward air injection in the event of their vertical takeoff, landing and hovering. Coordinating with the combined nozzle holes that can help balance the aircraft by their injection force can use them. In addition, it also can select to arrange the effusers for vertical take-off and landing in the outer ring of the lower layer of the aircraft. The advantage of the effusers in the outer ring of the lower layer is can provide better stability for the take-off and landing of aircrafts than that when they are located in the center, the disadvantage is to need a bigger space.

Hovering in the air: it can be realized by using the combined-nozzle-hole-based injection hovering mode. As, at this time, the aircraft to does not need a big upward thrust, the only thing is to guarantee the balance between the its downward gravity and the upward force of aircraft, of course, it also depends on whether the injection force of the combined nozzle holes is able to support the gravity of the aircraft.

See FIG. 9: The Design of the Combined Spray Heads Arrangement of Aircrafts

Aircraft is a circular object, the inventor designed the combined nozzle holes to be the circular shape with the same quantity of the combined nozzle holes arranged in the upper and lower surface layers and with the symmetric installation locations. This same quantity and symmetric arrangement can guarantee the synchronization of orbit-transfer by injection (see FIG. 9), when opening the combined nozzle holes as in following form (see FIG. 10), it requires to have an application result that allows the aircraft to launch at 30 degree angle (see FIG. 10-A) or landing (see FIG. 10-B), and the break effect when aircraft is in flight (see FIG. 10-C).

See FIG. 10-A aircraft launch: Open the effusers for vertical takeoff and landing to allow the aircraft to be launched to a certain height, then open 15C and 15D effusers to make the aircraft advance toward the horizontal direction; when crawling up, close the vertical launch effusers to and open the combined nozzle holes in the lower layer at the same time, as the lifting force of the horizontal airflow is obstructed by the vertical injection gas from the spray heads, the direction of the airflow is forced to change, and the aircraft will move with its head upward, resulting in a slanted upward orbit-transfer flight.

See FIG. 10-B aircraft landing: When the aircraft needs landing while it is in the horizontal flying, close 15C and 15D effusers, and the aircraft will maintain its flying under the inertia of flight speed. Open the combined nozzle holes in the upper layer, because the horizontal airflow in the upper surface of the aircraft is resisted by the vertical airflow from the spray heads, the direction of the airflow has to be changed and the aircraft will move with its head downward, resulting in a slanted downward orbit-transfer flight.

See FIG. 10-C braking effect: when the aircraft needs to be immobilized while it is doing horizontal flight, close 15C and 15D effusers, due to inertia, the aircraft will maintain its forward flying; then open the combined nozzle holes in the upper and lower layers, the horizontal airflow and the vertical injection airflow will form a confrontation vertically as like a air wall to obstruct the forward movement of the aircraft, resulting in a braking effect.

See FIG. 10-D & FIG. 10-E: aircraft left and right turn orbit-transfer flight diagram: The combined nozzle holes have same arrangement in the upper and lower surface layers of the aircraft with symmetric installation locations. This kind of symmetric arrangement and installation can guarantee the synchronization of aircraft's orbit-transfer by injection.

See FIG. 10-D turn-left orbit change: When an aircraft needs a left-turn orbit change while doing horizontal flight movement, open the combined nozzle holes in the upper and lower layers for 45 degree turn-left orbit change, as the horizontal airflow is encountered with the resistance of the injected airflow barrier; the heading of the aircraft will turn to left direction, resulting in the transfer of the orbit. When the orbit-transfer angle is achieved, close the combined nozzle holes and the aircraft will fly along the changed direction.

See FIG. 10-E turn-right orbit change: When an aircraft needs a right-turn orbit change while doing horizontal flight movement, open the combined nozzle holes in the upper and lower layers for 45 degree turn-right orbit change, as the horizontal airflow is encountered with the resistance of the injected airflow barrier; the heading of the aircraft will to turn to right direction, resulting in the transfer of the orbit. When the orbit-transfer angle is achieved, close the combined nozzle holes and the aircraft will fly along the changed direction.

See FIG. 11 and FIG. 12 for the application of the invention in is the helicopters: When applying the “fluid injection dynamic orbit-transfer system” to the helicopters, it must combine the amphibious movement devices (i.e. sea, land and air carrying vehicles) for consideration. In regarding a low-altitude, low-speed transport vehicle that can work either in air, or on land or on water, the main consideration for design is how to remove the propeller blades on a helicopter's head, and the “ultra-high-pressure fluid injection dynamic orbit-transfer system” can achieve this goal.

Firstly, use the effuser installed in the bottom of an aircraft to provide part of vertical lifting force for the helicopter, then install a polygonal rotating disk, either a quadrangle, or a hexagonal or a octagonal, in the top of the bearing of the helicopter's propeller, and the combined nozzle hole system can be installed on the surface of each disk. Both the middle of the bearing and the middle of connected rotating disc are hollow for transport of the air, in this way, the rotating disk on the top can be provided with air; while the axis is in high-speed rotation, the combined nozzle holes on the side of the top disc will inject airflow out, and the air to injected is shaped like the propeller blades. Therefore, such design has transferred the original “visible propeller blades” to the “invisible propeller blades” of the helicopter.

Although there are injections from the bottom effusers to help provide forces, the launching force may not be as big as that of “visible propeller blades” to bear the gravity, but we can increase the engine power to increase the air pressure and the invisible blades to increase its launching force. The real situation of this imagination can be verified through tests. Helicopter's self-rotation effect and orbit transfer issue can be addressed by installing the “orbit transfer system” at the proper locations of the fuselage. As the propeller blades have been changed from the “visible” to “invisible”, the safety factor has been greatly increased. When in navigation on the water, turn off the upward invisible propeller valve, instead turn to the backward injection mode, which acts as a thrust for forward navigation.

See FIG. 13 for the application of the invention in rockets and to missiles: All existing missiles have equipped with the intelligent control system, but no matter how intelligent the missile is, the orbit transfer has to rely on the heavy wing to complete. Hiow to help missiles to change the status quo and make them lighter, simpler in structure, and more flexible in maneuver orbit transfer, the answer is to install the combined nozzle holes of the “ultra-high-pressure fluid injection dynamic orbit-transfer system” in the missiles. The specific method is as follows: install injection effusers in the pressure compartment of the missile for the use of the combined holes in orbit transfer; in the surface layer of the missile, install the combined spray heads in the proper locations of the missile body and the injection mode will be controlled by the central automatic controller, thus producing a variety of modes and methods for the orbit transfer.

1. This is a kind of ultra-high-pressure fluid injection dynamic orbit-transfer system used in aircrafts, including air pipelines, combined nozzle holes and the central control system. It is featured by the foresaid orbit-transfer system along with the combined nozzle holes that are comprised of a number of cellular-geometry-shaped spray heads. The foresaid combined nozzle holes are installed either in the leading edge and the trailing edge, or in the trail fin or the ventral fin or the canard or the symmetrical planes of fuselage. The foresaid orbit-transfer system to also includes one or more air pressure storage device(s), for which the engine supplies the gas. The air pressure storage device connects with the combined nozzle holes through the gas pipeline. The downward effuser is installed in the underneath of the said air pressure storage device.

2. The orbit-transfer system used in the aircrafts described in claim 1 is featured by the said spray-heads with both the fixed spraying heads and the flexible spraying heads. The flexible spraying heads can spray in multiple directions by changing the angles of the rotating spray-heads.

3. The orbit-transfer system used in the aircrafts described in claim 1 is featured by the utilization in the military and civilian airplanes with the tail fin. The combined nozzle holes are coherently arranged in the symmetrical upper and lower parts of the leading edge of the aircraft wings, constituting the coherently arranged upper, middle and lower combined nozzle holes. The symmetric upper and lower parts of the trailing edge of the aircraft are coherently arranged with the combined nozzle holes, constituting the upper, middle and lower coherently arranged combined nozzle holes. In the symmetric sides of the tail of the aircraft, there are combined nozzle holes; in the symmetric upper and lower surfaces of the tail of the aircraft, there are combined nozzle holes. In the bottoms of the two middle-axle-symmetric sides of the fuselage or the wing-symmetric bottoms, effusers are arranged with; within the to fuselage or the wings are equipped with the air pressure storage devices.

4. The orbit-transfer system used in the aircrafts described in claim 1 is featured by the utilization in the military airplanes without tail fins. The combined nozzle holes are coherently arranged in the symmetrical upper and lower parts of the leading edge of the said no-tail-fin aircraft wings, constituting the upper, middle and lower coherently arranged combined nozzle holes. The symmetric upper and lower parts of the trailing edge of the aircraft wing are coherently arranged with the combined nozzle holes, similarly constituting the upper, middle and lower coherently arranged combined nozzle holes. In the symmetric upper and lower surfaces of the wing's tail perpendicular to the tail fin or the ventral fin are arranged with the combined nozzle holes; in the abdominal part or the bottom of the wing, in the-middle-axle symmetric parts are arranged effusers; and within the fuselage or the wings are equipped with the air pressure storage devices.

5. The orbit-transfer system used in the aircrafts described in claim 1 is featured by the utilization in helicopters. On the top of the bearing of a helicopter's propellers is installed one quadrangular or hexagonal or octagonal rotating disk. On the side of the polygonal rotating disk, there are combined nozzle holes. The central part connecting to the bearing in the inner part of the rotating disk is hollow, and the gas is transported to the combined nozzle holes in the polygonal rotating disk on the top of to the bearing through the hollow bearing.

6. The orbit-transfer system used in the aircrafts described in claim 1 is featured by the utilization in rockets or missiles. The combined nozzle holes are arranged in the surface layer of the shell of the rocket or missile described.

7. Its circular disc shape features the orbit-transfer system used in the aircrafts. The aircraft is divided into the upper, middle and lower layers. In the middle of the upper part of the middle and lower layers of the aircraft, the storage device is arranged. In the central point of the middle layer of the aircraft are arranged four outlets of the exhaust effusers in four directions with 90-degree angles and the said four outlets of the exhaust effusers have the upper and lower layers of nozzle mouths respectively. In the middle of the inner side of the upper and lower layers of nozzle mouths are equipped with effuser valve. On the bottom of the said storage device, there is a row of circular-type effusers with downward injection; in the upper and lower surface layers of the said aircraft, there are combined nozzle holes respectively.

8. The orbit-transfer system used in the aircrafts described in claim 7 is featured by the said effusers and the combined nozzle holes that are arranged with the circular shape radiating outward from the center of the circle.

9. The orbit-transfer system used in the aircrafts described in claim 7 is featured by the certain degree of angle between the nozzle mouths in the to upper and lower layers of the middle layer effusers and the nozzle mouth valve of the aircraft.

10. The orbit-transfer method used in the aircrafts described in claim 7 is featured by the following application methods: (A) Flight: when the two adjacent effusers in the middle layer of the disc aircraft blow off, the flying disc will make forward horizontal flying movement; when closing one effuser at one side and open another adjacent effuser in other side to blow off, the flying disc will make 90 degree orbit-transfer flight; when close two open effusers and open other two opposite effusers to blow off, the flying disc will be immobilized or do backward horizontal movement of flight; (B) Aircraft takeoff: open the downward-injection effuser, allowing the aircraft to launch vertically to a certain height, then open No. 3 and No. 4 effusers to make the aircraft advance horizontally; when the aircraft crawling up, close the effuser making vertical advancement, at the same time, open the combined nozzle holes in the specified location of the lower layer control device. Because the horizontal airflow in the lower surface of the flying aircraft is resisted by the vertical airflow from the combined nozzle holes, the direction of the airflow has to change and the aircraft will move with its head up, resulting in a slanted upward orbit-transfer flight; (C) Aircraft landing: close No. 3 and No. 4 effusers and the aircraft will maintain its flying under the inertia of flight speed. Open the combined nozzle holes in the specified location of the upper controller to blow off, because the horizontal airflow in the upper surface of the aircraft is resisted by the vertical airflow from the combined nozzle holes, the direction of the airflow has to change and the aircraft will move with its head down, resulting in a slanted downward orbit-transfer flight; (D) Using the combined nozzle holes to brake: when the aircraft needs to be immobilized while it is doing horizontal flight, close No. 3 and No. 4 effusers, due to inertia, the aircraft will maintain its forward flying; then open the combined nozzle holes on the specified locations of the upper and lower controllers, the horizontal airflow will have a vertical confrontation with the airflow injected and resist the forward movement of the aircraft, resulting in a braking effect; (E) Left-turn orbit-transfer: when an aircraft needs a left-turn orbit change while doing horizontal flight movement, open the 45 degree turn-left combined nozzle holes at the specified location of the upper and lower controllers, as the horizontal airflow is encountered with the resistance of the injected airflow barrier, the heading of the aircraft will turn to left direction, resulting in the change of the orbit. When the orbit-transfer angle is achieved, close the combined nozzle holes and the aircraft will fly along the changed direction; (F) Right-turn orbit-transfer: when an aircraft needs a right-turn orbit change while doing horizontal flight movement, open the 45 degree turn-right combined nozzle holes at the specified location of the upper and lower controllers, as the horizontal airflow is encountered the resistance of the injected airflow barrier, the heading of the aircraft will turn to right direction, resulting in the change of the orbit. When the orbit-transfer to angle is achieved, close the combined nozzle holes and the aircraft will fly along the changed direction.
